(19) United States
(12) Patent Application Publication
(10) Pub. No.: US 2014/0291105 A1
(43) Pub. Date: Oct. 2, 2014

(54) ELECTROMAGNETIC CLUTCH AND METHOD FOR MANUFACTURING SAME

(71) Applicant: DENSO CORPORATION, Kariya-shi, Aichi (JP)

(72) Inventors: Shigeyoshi Sakuraba, Kariya-shi (JP); Yasuo Tabuchi, Kariya-shi (JP); Youichi Murakami, Kariya-shi (JP)

(21) Appl. No.: 14/355,243

(22) PCT Filed: Nov. 2, 2012
(86) PCT No.: PCT/JP2012/078515

§ 371 Date: Apr. 30, 2014

(30) Foreign Application Priority Data
Nov. 8, 2011 (JP) 2011-244675

(51) Int. Cl. F16D 27/112

(52) U.S. Cl. CPC F16D 27/112
USPC 192/84.9; 29/896.91

(57) ABSTRACT

An electromagnetic clutch with improved transmission torque by means of a low-cost method includes an electromagnetic coil, a rotor that is rotary driven by means of an external drive source, an armature attracted to the rotor by means of a magnetic force of the electromagnetic coil, and a hub structure. The electromagnetic clutch is characterized in that a recessed and projected surface having a surface roughness of 10 μm or more and a hardness of 4 GPa or less is formed on the friction surface of the rotor and/or the friction surface of the armature.

### TECHNICAL FIELD

The present invention relates to an electromagnetic clutch which transmits and cuts off rotational power, more particularly relates to an electromagnetic clutch which has an excellent transmitted torque.

### BACKGROUND ART

An electromagnetic clutch is a mechanism which transmits and cuts off electric power to an electromagnet to transmit and cut off drive power. It is used for an electromagnetic clutch etc. for a compressor of a vehicular air-conditioner. By using an electromagnetic clutch, when the air-conditioner is not running, the engine and the compressor can be cut off in power, so this reduces the engine load and improves the fuel economy. Further, this is desirable from the viewpoint of the lifetime of the compressor.

An electromagnetic clutch is provided with a rotor which is driven to rotate by an engine through a belt etc., an armature which is arranged facing this rotor across a predetermined fine interval, and a hub structure which connects this armature to a rotary shaft at the compressor side.

Explaining this in further detail with reference to FIG. 1, a general electromagnetic clutch (10) is provided with an electromagnetic coil (18) which is stored in a stator (17), a rotor (16) which is driven to rotate by an engine (not shown), and a hub structure (11).

The hub structure (11) has an inner hub (15) and leaf springs (13) which are connected to the inner hub (15). The leaf springs (13) are joined to the armature (12) in the structure.

The electromagnetic clutch (10) is engaged and disengaged by magnetizing the electromagnetic coil (18) to make the frictional surface (12a) of the armature (12) be attracted to the frictional surface (16a) of the rotor (16) and by demagnetizing the electromagnetic coil (18) to make the armature (12) separate from the rotor (16).

From the past, various methods have been proposed for improving the transmitted torque of an electromagnetic clutch.

PLT 1 discloses, as a technique for improving the transmitted torque of the clutch, the method of bonding a frictional material to a rotor. According to this method, it is possible to improve the transmitted torque without increasing the diameter of the frictional surface, that is, within a limited space.

PLT 2 discloses, as a technique for improving the transmitted torque of the clutch, the method of bonding a coating material which has a resin on the frictional surface.

### CITATION LIST

### Patent Literature

PLT 1: Japanese Patent Publication No. 2009-299720A

PLT 2: Japanese Patent Publication No. 8-114241A

### SUMMARY OF INVENTION

### Technical Problem

The method described in PLT 1 increases the number of parts and increases the processing, so there is the problem of a higher cost. The method described in PLT 2 improves the transmitted torque right after the start of use, but if the frictional surface is worn, there is the problem of a drop in the transmitted torque.

The present invention was made in consideration of the above problems and has as its object the provision of an electromagnetic clutch which uses an inexpensive method to improve the transmitted torque and a method of production of the same.

### Solution to Problem

The inventors studied in depth the method of inexpensively improving the transmitted torque of an electromagnetic clutch.

As a result, they discovered that by forming fine relief structures on the frictional surface of the roller with the armature and/or on the frictional surface of the armature with the rotor, it is possible to inexpensively improve the transmitted torque.

The present invention was made based on this discovery and provides an electromagnetic clutch (10) which is provided with an electromagnetic coil (18), a rotor (16) which is driven to rotate by an external drive source, an armature (12) which is attracted to the rotor (16) by magnetic force of the electromagnetic coil (18), and a hub structure (11), the electromagnetic coil (18) being magnetized to make a frictional surface (12a) of the armature (12) be attracted to a frictional surface (16a) of the rotor (16) and the electromagnetic coil (18) being demagnetized to make the armature (12) separate from the rotor (16) and thereby transmit and cut off power, the electromagnetic clutch characterized in that a frictional surface (16a) of the rotor (16) and/or a frictional surface (12a) of the armature (12) is formed with a relief surface with a surface roughness Rz of 10 μm or more and a hardness of 4 GPa or less.

By providing the frictional surface (16a) of the rotor (16) and/or the frictional surface (12a) of the armature (12) with fine relief surfaces, when the clutch is ON, the frictional surface (16a) of the rotor (16) and the frictional surface (12a) of the armature (12) increase in frictional surface area, so the transmitted torque is improved.

In the electromagnetic clutch (10) of the present invention, the rotor (16) can be comprised of low carbon steel with a C content of 0.3% or less.

The rotor (16) forms a magnetic circuit (21) when attracted to the armature (12), so a material with a low C content is suitable. Further, a low carbon material is low in hardness of the material, so it becomes possible to inexpensively form relief surfaces such as explained above on the surfaces.

The rotor and armature of an electromagnetic clutch are generally formed in a double cylindrical shape through a plurality of bridge parts with a flange part provided integrally with it. In such a case, the bridge parts of the rotor (16) are preferably not formed with the above-mentioned relief surfaces. This is because if forming relief surfaces of the bridge parts, sometimes the bridge parts fall in strength.

The electromagnetic clutch (10) of the present invention can be formed with the frictional surface (16a) of the rotor (16) and/or the frictional surface (12a) of the armature (12) by processing using blasting materials.

Specifically, the blasting materials are made to strike the frictional surface (16a) of the rotor part and/or the frictional surface (12a) of the armature part before assembly to roughen the frictional surfaces and form relief surfaces.

In the method of production of the electromagnetic clutch (10) of the present invention, as the method for blasting the blasting materials on the surface to be processed, air blasting which uses compressed air to blast the blasting materials is preferable.

The blasting materials which are used in the method of production of the electromagnetic clutch (10) of the present invention preferably have a hardness of at least two times the hardness of the frictional surface (16a) of the rotor (16) and/or the frictional surface (12a) of the armature (12) of the surfaces to be processed. Due to this, it becomes possible to easily form relief surfaces on the frictional surface (16a) of the rotor (16) and the frictional surface (12a) of the armature (12).

As the blasting materials which can be used in the present invention, particle size 0.5 to 3 mm or so steel, Al₂O₃, SiC, etc. may be mentioned.

Note that the numerals in parentheses attached to the means show examples of correspondence with specific means described in the later explained examples.

### Advantageous Effects of Invention

According to the present invention, it is possible to increase the frictional surface area of the frictional surface (16a) of the rotor (16) and the frictional surface (12a) of the armature (12) of the electromagnetic clutch (10), so it is possible to obtain an electromagnetic clutch (10) which has an excellent transmitted torque.

### BRIEF DESCRIPTION OF DRAWINGS

FIG. 1 is a view which shows an example of a cross-section of an electromagnetic clutch according to the present invention and shows the state where the clutch is OFF.

FIG. 2 is a view which shows an example of a cross-section of an electromagnetic clutch according to the present invention and shows the state where the clutch is ON.

FIG. 3 is a view which shows a side surface of an electromagnetic clutch according to the present invention.

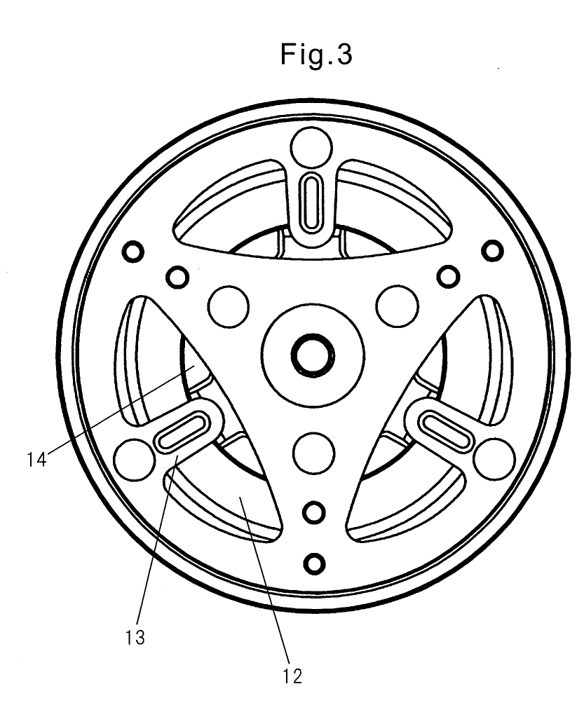

FIG. 4 is a view which shows an outline of an air blast system which can be used for the present invention.

FIG. 5 is a view which shows one example of blasting materials which can be used for the present invention.

FIG. 6 is a view which shows the surface conditions of a frictional surface of a rotor after being treated by air blasting according to the present invention.

FIG. 7 is a view which shows results of evaluation of the transmitted torque of an electromagnetic clutch according to the present invention.

### DESCRIPTION OF EMBODIMENTS

The present invention is described with reference to a specific embodiment which is selected for the purpose of illustration, but it will be clear to a person skilled in the art that numerous changes can be made without departing from the basic concept of the present invention and its scope of disclosure. The present invention will be understood more clearly if referring to the description of embodiments of the present invention as explained below with reference to the attached drawings.

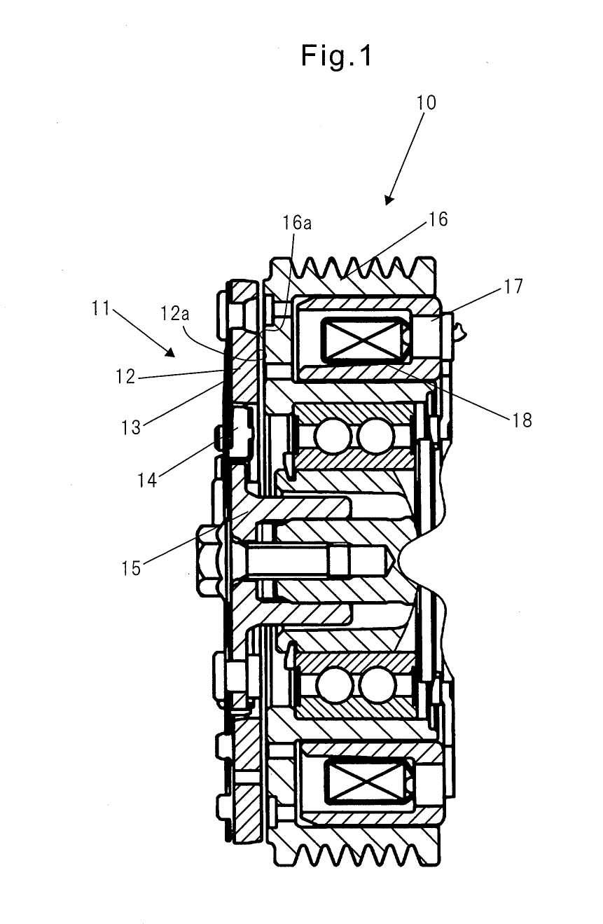

FIG. 1 is a view which shows a cross-section of an electromagnetic clutch (10) in the state where the clutch is OFF. In the state where the clutch is OFF, the armature (12) and the rotor (16) are separated in state.

In this state, the rotational power from the engine is just transmitted to the rotor (16) and is not transmitted through the armature (12) to the hub structure (11). The rotor (16) races in this state.

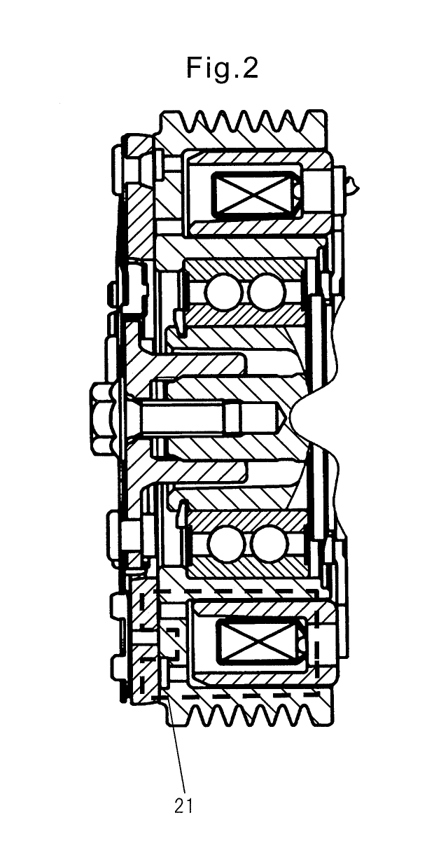

FIG. 2 is a view which shows a cross-section of an electromagnetic clutch (10) in the state where the clutch is ON. At this time, the frictional surface (12a) of the armature (12) is attracted by the magnetic force of the electromagnetic coil (18) to the frictional surface (16a) of the rotor (16). The torque is transmitted through the attracted frictional surface to the hub structure (11). Further, the armature (12) and rotor (16) form a magnetic circuit (21).

The frictional surface (16a) of the rotor (16) and/or the frictional surface (12a) of the armature (12) of the electromagnetic clutch (10) of the present invention are formed with relief surfaces with a surface roughness Rz of 10 μm or more and a hardness measured by a nano indenter of 4 GPa or more. The relief shapes do not have to be regularly arranged and may also be randomly arranged.

The surface roughness Rz which is referred to here is the 10-point average roughness which is prescribed by the Japan Industrial Standard (JIS B 0601-1994) and is a value which is measured by a surface roughness measuring device which is generally known to a person skilled in the art.

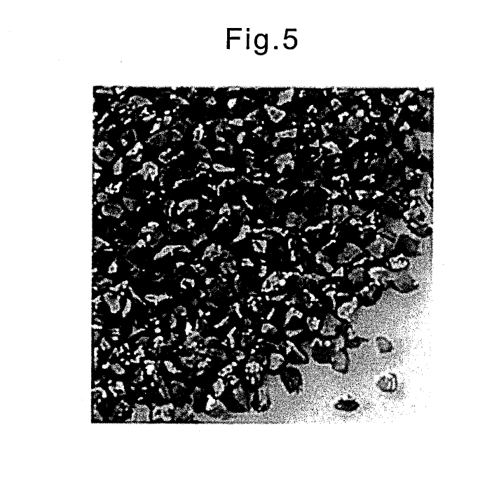

Such a relief surface can be formed by making sharp polygonal shaped blasting materials such as shown in FIG. 5 strike the frictional surface (16a) of the rotor (16) and/or the frictional surface (12a) of the armature (12). The force propelling the blasting materials can be sufficiently provided by compressed air. A high pressure such as with shot blasting is not required, so in production of the electromagnetic clutch of the present invention, it is preferable to use blasting by air blasting.

If relief surfaces with a surface roughness Rz of 10 μm or more and a hardness measured by a nano indenter of 4 GPa or less are present on the entire surfaces of the frictional surfaces (16a, 12a), the effect of improvement of the transmitted torque can be exhibited to the maximum extent. However, the relief surfaces do not need to be formed on the entire surfaces of the frictional surfaces (16a, 12a). It is sufficient to form the relief surfaces over at least predetermined areas for giving the necessary effect of improvement of the transmitted torque.

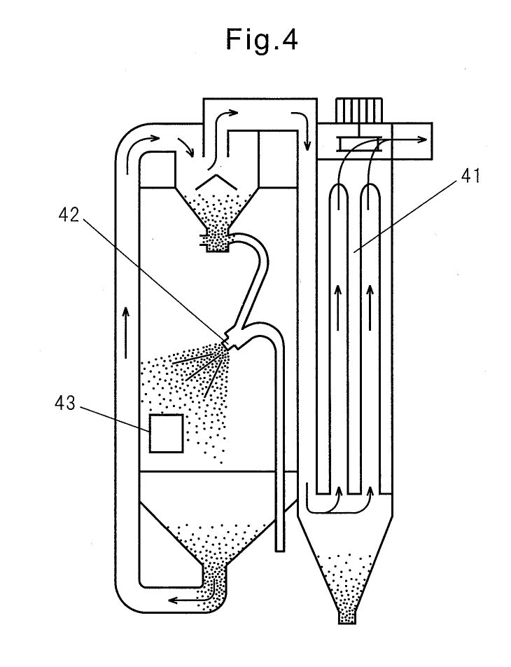

FIG. 4 shows one example of an air blasting system. In the system of FIG. 4, the blasting materials are sucked up by the force of the air of a dust collector (41). The sucked up blasting materials are blasted toward the work (43) by an air gun (42) using the force of compressed air.

Air blasting has been used since the past for deburring using spherical blasting materials etc. In the method of production of the electromagnetic clutch (10) of the present invention, the object is to make the blasting materials strike the material to be processed so as to form relief surfaces, so the blasting materials are not the spherical shape which is used for deburring etc. Sharp polygonal shape ones are used.

Due to this, the frictional surface of the rotor (16) and/or the frictional surface of the armature (12) of the material to be processed are gouged and relief surfaces are formed. This is a characterizing feature of the present invention. If using spherical blasting materials, the material to be processed is not gouged and the relief surfaces forming the characterizing feature of the present invention are not formed.

Further, if the hardness of the blasting materials is two times or more the hardness of the surface to be processed, the surface to be processed is gouged, so this is preferable for forming the relief surfaces. Here, the “hardness” means the value measured using a nano indenter and expressed by (maximum load)/(contact area of indenter and sample).

As the material of the specific blasting materials which can be used in the present invention, for example, steel, Al₂O₃, SiC, etc. can be mentioned. Two or more of these may also be used mixed. Of course, there is no problem even if some impurities etc. are included. Further, the particle size of the blasting materials is preferably 0.5 to 3 mm or so.

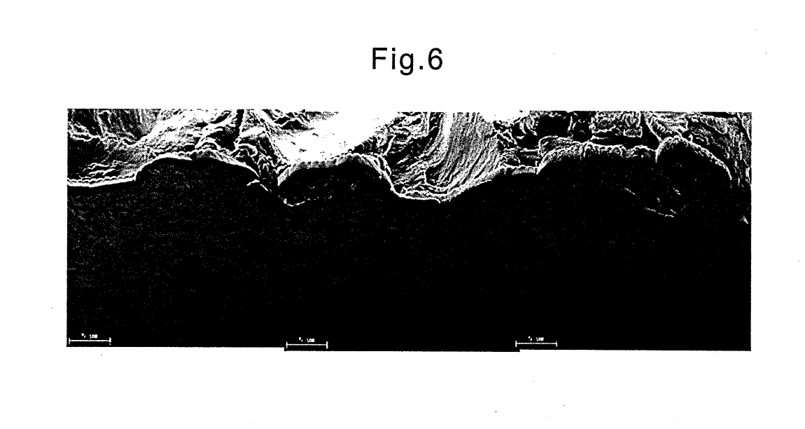

FIG. 6 shows the surface conditions of a worked frictional surface. It can be confirmed that relief shapes are formed at the surface and that a sponge-like layer of a depth of 20 μm or so is formed. Due to this, when the frictional surface (16a) of the rotor (16) and the frictional surface (12a) of the armature (12) contact, the frictional surface area becomes larger, so the transmitted torque is improved.

The relief surfaces may be formed at either of the frictional surface (16a) of the rotor (16) and the frictional surface (12a) of the armature (12) which contact each other to transmit torque, but may also be formed at both. Further, the relief surfaces are preferably formed at the entire circumferences of the frictional surfaces, but the effect of the present invention may also be obtained even if applied to just parts.

Further, the frictional surface (16a) of the rotor (16) and the frictional surface (12a) of the armature (12) have sometimes been coated with an extreme pressure agent in the past to prevent surface roughness at the time of engagement and disengagement of the clutch. If applying the present invention to such surfaces, the result becomes the microstructure such as shown in FIG. 6, whereby the effects are obtained that the ability to hold an additive becomes better and surface roughness can be prevented more.

Further, even when other surface treatment is performed, by applying the present invention to the surfaces to form a microstructure, the surface treatment material is buried in the iron material, so it is possible to obtain the effect of improvement of the corrosion resistance, improvement of the transmitted torque, prevention of sticking, etc.

### EXAMPLES

An air blasting system (made by Sintokogio, MY-30B) was used to blast commercially available steel blasting materials (made by Sintokogio, SB Steel Grit GH-3) on the frictional surface of the rotor of the magnetic clutch.

The blasting conditions were made a compressed air pressure of 0.3 MPa, a blasting distance of 15 cm, and a blasting time of 10 seconds. A single blasting operation was performed.

The hardness of the frictional surface of the rotor before blasting was measured by a nano indenter whereupon it was 4.3 GPa, while after blasting, it was 1.2 GPa.

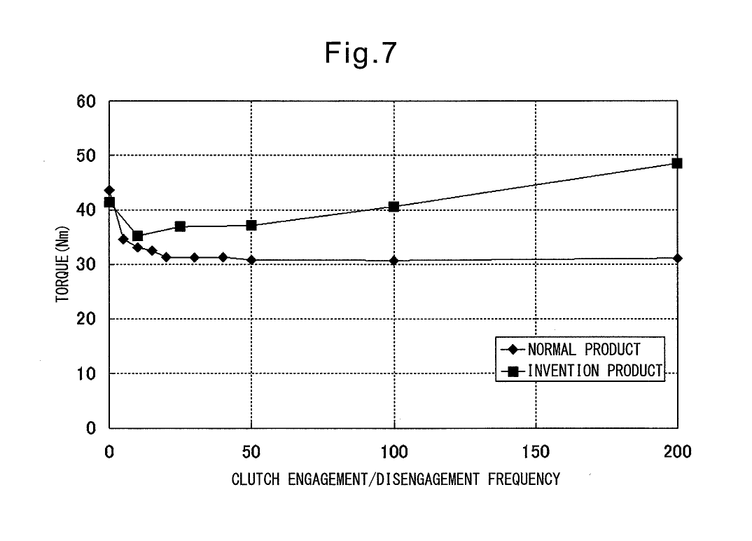

FIG. 7 shows a comparison of transmitted torques of an electromagnetic clutch which uses a rotor which is treated as in the present invention and is formed with a relief surface on its frictional surface and a conventional electromagnetic clutch. As clear from the results of FIG. 7, according to the present invention, it could be confirmed that the transmitted torque is improved 10% compared with a conventional electromagnetic clutch.

Note that embodiments of the present invention were explained by giving specific examples, but the present invention is not limited to these examples. Various modifications not departing from the description of the claims and within the range able to be easily conceived of by a person skilled in the art are also included in the present invention needless to say.

### REFERENCE SIGNS LIST

10 electromagnetic clutch
11 hub structure
12 armature
12a frictional surface of armature
13 leaf spring
14 damper
15 inner hub
16 rotor
16a frictional surface of rotor
17 stator
18 electromagnetic coil
21 magnetic circuit
41 dust collector
42 air gun
43 work

1. An electromagnetic clutch comprising:
an electromagnetic coil,
a rotor which is driven to rotate by an external drive source,
an armature which is attracted to said rotor by magnetic force of said electromagnetic coil, and
a hub structure, wherein
said electromagnetic coil is magnetized to make a frictional surface of said armature be attracted to a frictional surface of said rotor and,
said electromagnetic coil being is demagnetized to make said armature separate from said rotor and thereby transmit and cut off power, and
a frictional surface of said rotor and/or a frictional surface of said armature is formed with a relief surface with a surface roughness Rz of 10 μm or more and a hardness of 4 GPa or less.

2. The electromagnetic clutch according to claim 1, wherein said rotor is comprised of a low carbon steel with a C content of 0.3% or less.

3. The electromagnetic clutch according to claim 1 wherein bridge parts of said rotor and/or said armature are not formed with said relief shape surface.

4. A method of production of an electromagnetic clutch which is provided with an electromagnetic coil, a rotor which is driven to rotate by an external drive source, an armature which is attracted to said rotor by magnetic force of said electromagnetic coil, and a hub structure, said electromagnetic coil being magnetized to make a frictional surface of said armature be attracted to a frictional surface of said rotor and said electromagnetic coil being demagnetized to make said armature separate from said rotor and thereby transmit and cut off power, said method of production of an electromagnetic clutch characterized in that a frictional surface of said rotor and/or a frictional surface of said armature is formed with a relief surface with a surface roughness Rz of 10 μm or more and a hardness of 4 GPa or less using sharp polygonal shaped blasting materials.

5. The method of production of the electromagnetic clutch according to claim 4 wherein said processing is performed by using air blasting to blast said blasting materials on the frictional surface of said rotor and/or the frictional surface of said armature.

6. The method of production of the electromagnetic clutch according to claim 4 wherein said blasting materials have a hardness of two times or more of the hardness of the surface to be processed of the frictional surface of said rotor and/or the frictional surface of said armature.

7. The method of production of the electromagnetic clutch according to claim 4 wherein said blasting materials are comprised of one or more materials selected from steel, Al₂O₃, and SiC.

8. The method of production of the electromagnetic clutch according to claim 4 wherein said processing is performed on bridge parts of said rotor and/or said armature.

9. The electromagnetic clutch according to claim 2 wherein bridge parts of said rotor and/or said armature are not formed with said relief shape surface.

10. The method of production of the electromagnetic clutch according to claim 5 wherein said blasting materials have a hardness of two times or more of the hardness of the surface to be processed of the frictional surface of said rotor and/or the frictional surface of said armature.

11. The method of production of the electromagnetic clutch according to claim 5 wherein said blasting materials are comprised of one or more materials selected from steel, Al₂O₃, and SiC.

12. The method of production of the electromagnetic clutch according to claim 6 wherein said blasting materials are comprised of one or more materials selected from steel, Al₂O₃, and SiC.

13. The method of production of the electromagnetic clutch according to claim 10 wherein said blasting materials are comprised of one or more materials selected from steel, Al₂O₃, and SiC.

14. The method of production of the electromagnetic clutch according to claim 5 wherein said processing is performed on bridge parts of said rotor and/or said armature.

15. The method of production of the electromagnetic clutch according to claim 6 wherein said processing is performed on bridge parts of said rotor and/or said armature.

16. The method of production of the electromagnetic clutch according to claim 7 wherein said processing is performed on bridge parts of said rotor and/or said armature.

17. The method of production of the electromagnetic clutch according to claim 10 wherein said processing is performed on bridge parts of said rotor and/or said armature.

18. The method of production of the electromagnetic clutch according to claim 11 wherein said processing is performed on bridge parts of said rotor and/or said armature.

19. The method of production of the electromagnetic clutch according to claim 12 wherein said processing is performed on bridge parts of said rotor and/or said armature.

20. The method of production of the electromagnetic clutch according to claim 13 wherein said processing is performed on bridge parts of said rotor and/or said armature.
